(19) United States
(12) Patent Application Publication
(10) Pub. No.: US 2017/0101329 A1
(43) Pub. Date: Apr. 13, 2017

(54) INHIBITION OF SENSOR BIOFOULING

(71) Applicant: SCHLUMBERGER TECHNOLOGY CORPORATION, Sugar Land, TX (US)

(72) Inventors: Nathan Scott Lawrence, Cambridge (GB); Steven Antony Gahlings, Cambridge (GB)

(21) Appl. No.: 15/290,819

(22) Filed: Oct. 11, 2016

(30) Foreign Application Priority Data
Oct. 8, 2015 (GB) 1517856.9

(51) Int. Cl. C02F 1/46; G01N 21/15; G01N 27/30; G01N 27/38; C02F 1/461; G01N 27/416

(52) U.S. Cl. CPC C02F 1/4602; C02F 1/46109; G01N 27/4167; G01N 27/302; G01N 27/38; G01N 21/15; C02F 2001/46142; C02F 2303/20; C02F 2305/023

(57) ABSTRACT

Generating hydrogen peroxide in situ in a water environment to mitigate biofouling of a water sensor. A hydrogen peroxide generator submerged in the water environment generates hydrogen peroxide to remove/mitigate biofouling of the water sensor. The water sensor may be an electrochemical sensor and the hydrogen peroxide generator may be an electrochemical system that is integrated with the sensor. The water sensor may be able to operate without interference from the generated hydrogen peroxide.

### CROSS-REFERENCE TO RELATED APPLICATIONS

This application claims priority to Great Britain patent application serial number 1517856.9, filed Oct. 8, 2015 and titled INHIBITION OF SENSOR BIOFOULING, the entire disclosure of which is herein incorporated by reference.

### BACKGROUND

Embodiments of the present disclosure provide methods and systems for preventing and/or inhibiting biofouling at a sensor. Embodiments of the present disclosure comprise generating peroxide in the vicinity of the sensor. In some embodiments the sensor comprises an electrochemical sensor and the hydrogen peroxide generating apparatus is integrated with the electrochemical sensor. Also provided is a water sensing apparatus having a sensor and a peroxide generator, which is suitable for use in the methods of the invention.

Biofouling generally refers to the accumulation of biological material on surfaces that are exposed to or immersed in water. The biological material may include algae and other microorganisms, plants and animals, such as molluscs and sponges, amongst others.

The use of a water sensing apparatus can be limited by biofouling of the equipment. Biofouling may limit the mechanical operation of the water sensing equipment, or may otherwise interfere with the analytical measurements performed by the sensor within the apparatus, particularly where the sensor is an optical or electrochemical sensor. Where there is considerable biofouling (macro-fouling) this may alter the biological and chemical properties of the environment under analysis. Biofouling often prevents the long-term deployment and effective operation of sensors for water environments, such as Oceans, seas, rivers, lakes, reservoirs and/or the like.

Biofouling is a recognised as a limiting factor in underwater methods of analysis. Several methods for limiting biofouling have been developed, but these methods are often limited to particular sensor applications, and a truly universal practical solution to the problem of biofouling has not yet been developed.

Typically the prevention or inhibition of biofouling close to and at the sensor is a key aspect to the continuous operation of the sensor and the water sensing apparatus. To date a number of industrial approaches to limiting biofouling have been developed (see Delauney et al.).

A first general approach to limit biofouling is to coat surfaces with a material that is, or contains, a biocide, or a material that has non-adherence properties. However, whilst these techniques are often used to protect vessel hulls (for example), such systems are not commonly used to protect water sensing apparatus and their sensors.

The second approach is to use mechanical devices such as wipers and scrapers to remove biological material from sensor surfaces. This approach is relatively crude, and the mechanical devices may themselves become prone to biofouling. The mechanical complexity of some systems also gives rise to additional problems in operation and maintenance.

A third approach is based on the relatively uncontrolled generation of a biocide at the environment of the sensor. For example, reported methods include the dissolution of metallic ions such as copper ion in a corrosion mechanism, and the leaching of tributyltin compounds into the vicinity of the sensor. This latter method is now almost entirely avoided owing to the toxicity of tributyltin compounds, the use of which is now severely restricted in many places. Given the uncontrolled manner in which the biocide is released, this approach is generally not attractive. Moreover, the uncontrolled release may result in the biocide contaminating the environment being tested/monitored.

A fourth approach to preventing or limiting biofouling is to generate a biocide in a controlled manner. Thus, the biocide is prepared as and when it is required. For example, a chlorination biocide may be used to protect sensors. The chlorination biocide may be produced by seawater electro-chlorination. However, seawater electro-chlorination is not a viable method for use in reservoirs, rivers, lakes and/or the like.

The present inventors have developed a method of controlled biocide generation for preventing or inhibiting biofouling at a sensor.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth.

The inventors have established that peroxide, such as peroxide ion and/or hydrogen peroxide, may be used as a biocide for the prevention or inhibition of biofouling in a water sensing apparatus. Surprisingly, it has been found that the peroxide ion and/or hydrogen peroxide may be used to mitigate/prevent biofouling of a sensor/sensing element where the sensor/sensing element is underwater/submerged and/or where the fluid surrounding the peroxide ion and/or hydrogen peroxide is not flowing or is flowing in a slow and/or random fashion.

The invention generally provides a method for preventing or inhibiting biofouling in a water sensing apparatus. The method comprises the step of generating peroxide in the vicinity of a sensor of the water sensing apparatus, such as electrochemically generating peroxide.

Accordingly, in a first aspect of the invention there is provided a method for preventing or limiting biofouling of a water sensing apparatus, the method comprising the step of generating peroxide, such as electrochemically generating peroxide, in the vicinity of a sensor of the water sensing apparatus.

Hydrogen peroxide and the related peroxide ion are known for their biocidal activity, which is related to its oxidising activity. This activity is capable of killing cells or severely weakening cell membranes, often leading to severe loss of cell function. The use of peroxide as a biocide is attractive as the peroxide degrades relatively quickly in the aqueous environment, and the expected degradation products are innocuous (water and oxygen). Beneficially, this means that the environment local to the sensor is not substantially altered through use of a peroxide biocide compared to the bulk environment in which the water sensing apparatus is located.

Advantageously, peroxide may be generated from oxygen and water, both of which are present in the aqueous environment. In contrast, a chlorination-based biocide strategy requires the provision of a chlorine reservoir for the abundant and controlled supply of chlorine.

In a further aspect there is provided a water sensing apparatus comprising a peroxide generator, such as an electrochemical peroxide generator, and the water sensing apparatus is adapted for the analysis of an aqueous solution. Thus, the water sensing apparatus may further comprise a sensor in addition to the peroxide generator, or the peroxide generator may be operable as the sensor.

The water sensing apparatus may be provided underwater.

In yet a further aspect of the invention there is provided a method of analysing an aqueous solution, the method comprising the step of providing an aqueous solution to a sensor of a water sensing apparatus, generating peroxide in the vicinity of the sensor and analysing the aqueous solution using the sensor.

The peroxide may be generated prior to the analysis of the aqueous solution, or it may be generated simultaneously to the analysis of the aqueous solution. The peroxide is generated from oxygen within the aqueous solution.

In a further aspect of the invention there is provided the use of an electrochemical peroxide generator as an electrochemical sensor for the analysis of an aqueous solution. The inventors have realised that an electrochemical cell for generating peroxide from an aqueous solution may also be used to analyse a property of the aqueous solution. Thus, the electrochemical cell may be used to prevent or inhibit biofouling of the sensor, whilst also permitting analysis of aqueous samples, optionally simultaneously with the peroxide generation.

These and other aspects and embodiments of the invention are discussed in further detailed below.

### BRIEF DESCRIPTION OF THE FIGURES

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A illustrates a water sensing apparatus comprising an electrochemical cell and an electrochemical sensor, in accordance with embodiments of the present invention.

FIG. 1B illustrates a water sensing apparatus comprising an electrochemical hydrogen peroxide generator and an optical sensor, in accordance with embodiments of the present invention.

FIG. 2 is an illustration of a part of a water sensing apparatus showing a part of an electrochemical peroxide generator and an optical sensor for use in a method according to an embodiment of the invention, where an electrochemical peroxide generator has transparent cathodes immobilised to which is an anthroquinone (AQ) catalyst. An optical sensor having a light emitter and light detector is provided together with the transparent cathodes.

### DETAILED DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the scope of the invention as set forth in the appended claims.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

The method described herein comprises the step of generating peroxide in the vicinity of a sensor of a water sensing apparatus. The peroxide is used as a biocide to prevent or inhibit the growth of biological deposits in the water sensing apparatus, and usefully the biocide prevents or inhibits biofouling of the sensor, and most usefully at the sensor interface. The peroxide may be used to degrade biological deposits that are present on the water sensing apparatus. Thus, the method of the invention encompass the at least partial removal of biofouling from water sensing apparatus.

The method of the invention typically involves the electrochemical generation of peroxide at the cathode of an electrochemical cell. Such a cell may be referred to as an electrochemical peroxide generator. The electrochemical cell uses an aqueous solution containing dissolved oxygen to generate the peroxide. The aqueous solution is taken from the aqueous environment in which the water sensing apparatus is located.

The preparation of peroxide from water using electrochemical techniques has previously been described in G.B. Patent No. 2 513 103, the contents of which are hereby incorporated by reference in their entirety. It was noted in that case that the methods of preparation could be applied to the generation of hydrogen peroxide using water from a natural source such as a river or lake. The authors of this work have explained that the generation of hydrogen peroxide may serve to sanitise the water by killing or inhibiting the growth of unwanted microorganisms. Thus, the purpose of generating hydrogen peroxide is to improve the quality of the water.

An aspect of the reference is the generation of hydrogen peroxide using a flow of water. The flowing water is passed over the elements of an electrochemical sensor to produce an outflow of hydrogen peroxide. The hydrogen peroxide being produced by flowing water through the electrochemical system. The flow of the water and the configuration of the electrodes, in a tube or the like, being configured to provide for generating effective quantities of hydrogen peroxide for cleaning purposes.

This earlier work does not explicitly refer to the use of hydrogen peroxide to prevent or limit the growth of organisms on the surfaces of water sensing apparatus, such as the surfaces of a sensor contained within the apparatus, and nor does this earlier work refer to the generation of hydrogen peroxide in the vicinity of a sensor.

Water Sensing Apparatus

The method of the invention is for preventing or inhibiting biofouling in a water sensing apparatus. The water sensing apparatus is adapted for placement in an aqueous environment for the analysis of the water at that environment. The water sensing apparatus typically analyses an aqueous solution which is a sample from the aqueous environment.

The water sensing apparatus is provided with a sensor for analysing a property, such as an optical or electrochemical property, of the aqueous solution. For example, the sensor may be suitable for measuring the pH ([H⁺]) of an aqueous solution. The sensor may also be suitable for measuring the UV/vis absorbance of an aqueous solution. The sensor may also be suitable for detecting the presence of analytes such as hydrogen sulfide or oxygen.

The water sensing apparatus is provided with a peroxide generator, such as an electrochemical peroxide generator. The peroxide generator may be capable of functioning as the sensor also, or the peroxide generator may be provided in addition to a sensor.

The water sensing apparatus may be provided with a plurality of sensors. A peroxide generator may be provided for each of the sensors, or a single peroxide generator may be provided for supply of peroxide to each of the sensors.

The water sensing apparatus may be adapted for underwater use, and may be suitable for use in monitoring and analysing the properties of water in bodies of water such as seas, oceans, lakes, rivers and other waterways, and the like. The water sensing apparatus may be adapted for operation within water pipes or reservoirs, swimming pools and the like.

The water sensing apparatus may be located entirely underwater. It may be the case that part of the water sensing apparatus is underwater, including the part of the water sensing apparatus including the sensor.

The water sensing apparatus may be intermittently provided in water, such as in tidal locations where the water sensing apparatus is periodically taken up into water, or in riverways where changes in river flow periodically take the water sensing apparatus into and out of water.

It may be the case that the sensor and the peroxide generator are integrated. Thus a single device may perform sensing and peroxide generating functions. As described herein, peroxide may be generated electrochemically, and the electrochemical cell for use in this generation step may also be suitable for use as an electrochemical sensor for detecting the presence of an analytes within an aqueous solution. The generation of peroxide in the electrochemical cell inevitably prevents or limits biofouling of the sensing electrode, which is part of the sensor interface of the electrochemical cell, when used as an electrochemical sensor. This arrangement is described in further detail below.

In another arrangement, the peroxide generating unit and the sensor are separate. The peroxide generator is placed in close proximity to the sensor, and the peroxide generated is permitted to contact the sensor, thereby preventing or limiting biofouling of the sensor. This arrangement is also discussed in further detail below.

The apparatus may be additionally provided with an electrical power supply for providing electrical power to the sensor and the peroxide generating unit, and optionally other components of the apparatus.

The apparatus may be provided with one or more of the following: lighting (for lighting the apparatus for ease of detection), a transmitter and/or receiver, including a locating device, an outer casing to hold components, sampling devices and flow apparatus for taking an aqueous solution from the environment and distributing the aqueous solution within the apparatus to the sensor and the peroxide generator, and so on.

A reference to a sensor interface is a reference to that part of the sensor that analyses the aqueous solution. For example the sensor interface may be a light source and detector for an optical sensor, or it may be the electrodes for an electrochemical detector. It therefore refers to the active part of the sensor that contacts the aqueous solution for analysis.

Where, the peroxide generator and sensor are separate units they may be provided in a flow path, where the peroxide generator is provided upstream of the sensor. Peroxide generated by the generator is permitted to flow downstream to the sensor.

The peroxide generator may be provided in close proximity to the sensor to allow for generation of hydrogen peroxide in the region of the sensor. In particular, where the peroxide generator is an electrochemical peroxide generator, the cathode of the electrochemical cell is provided in close proximity to the sensor. The peroxide may be permitted to diffuse to the sensor or the peroxide may be directed to the sensor by a controlled flow of the aqueous solution into which the peroxide is generated.

The present invention also provides a water sensing apparatus comprising a peroxide generator, such as an electrochemical peroxide generator. As noted above, the water sensing apparatus may additionally comprise a sensor, or the peroxide generator may be suitable for use as a sensor, such as an electrochemical sensor.

The water sensing apparatus finds use in the methods of the invention. Thus, the peroxide generator is used to generate peroxide, and this peroxide is permitted to act to prevent or limit biofouling of the sensor, such as at the sensor interface.

The apparatus may be provided underwater.

The apparatus may be updated for use in seawater (a saline environment).

The methods of the invention may be performed whilst the water sensing apparatus is underwater.

The underwater sensor may remain underwater during the hydrogen peroxide generation and treatment steps.

It has been found that even though the sensor/sensing element of the sensor is surrounded by water, generation of hydrogen peroxide (H₂O₂) proximal to the sensor/sensing element has an anti-biofouling effect. Where the peroxide generator is integrated with an electrochemical sensor this effect may be improved. In some aspects, the H₂O₂ is generated proximal to the sensor/sensing element, whereas in other aspect flow of the water environment, whether naturally occurring or generated by a pump or the like, may be used to flow the H₂O₂ over the sensor/sensing element.

Generation of the H₂O₂ proximal to the sensor/sensing element does not have an adverse effect on sensor operation as the H₂O₂ breaks down back into H₂O. This return of the H₂O₂ back into H₂O preventing sensor interference or the like and the good, localized anti-biofouling effect of the H₂O₂ even in a submerged environment provides significant advantages over previous techniques for preventing sensor biofouling.

Generation of Peroxide

A reference here to peroxide is a reference to peroxide ion (HO₂⁻) or hydrogen peroxide (H₂0₂), and typically hydrogen peroxide. The method of the invention comprises the step of generating peroxide in an aqueous solution.

The peroxide may be generated from water and oxygen, where the oxygen may be dissolved with the water. Thus, the reagents for preparing the peroxide are obtained from the immediate aqueous environment in which the apparatus is provided. There is no need to provide reagents separately within the apparatus for the generation of a biocide.

The peroxide is therefore generated within an aqueous solution and the aqueous solution is permitted to contact those parts of the sensor where it is beneficial to prevent or limit biofouling.

The water may be from a natural water source such as an ocean, sea, river, lake or the like.

The water provided to the electrochemical cell may be from a natural water source without chemical purification.

The peroxide may be generated periodically, as and when required to prevent or limit biofouling. The peroxide may be generated to a schedule and the amount and duration of peroxide generation may be pre-determined. Here, the peroxide generator may be under the management of a suitably programmed control unit.

The peroxide generation may also be responsive to a perceived loss of performance in the sensor, which loss of performance is attributable to the biofouling of the sensor surfaces. The peroxide may be generated for an amount and time sufficient to restore the performance of the sensor. A loss of performance in the sensor may be determined from a change in a reference signal for the sensor.

The peroxide generation may also be controlled manually, for example in response to a visual inspection of the sensor.

The sensor may be operated after the step of generating peroxide. The operation of the sensor may be monitored, for example against a reference signal, and further peroxide may be generated as needed to ensure the reduction of biofouling of the water sensing apparatus.

The peroxide may be generated electrochemically. Peroxide may be generated at a working electrode, or cathode, of an electrochemical cell. Thus, the peroxide generator may be an electrochemical peroxide generator. Peroxide is generated when an electrical potential is applied to the cathode when it is exposed to an aqueous solution having oxygen dissolved within it. The oxygen is reduced, in the presence of water, to form peroxide.

The electrochemical cell may be provided with a cathode and an anode (or counter electrode), optionally together with a reference electrode.

A flow of an aqueous solution may be provided through the interelectrode space (the space between anode and cathode, for example). The flow is generated from an aqueous sample taken from the aqueous environment in which the apparatus is provided.

The electrochemical cell may also be provided with a reference electrode in communication with the aqueous flow and the electrical potential applied to the cathode may then be held at a constant potential relative to this reference electrode. Electronic devices able to supply a constant potential relative to a reference electrode are widely available as laboratory potentiostats. Such devices can also be scaled up to have a larger current-carrying capacity if required.

The electrochemical generation of peroxide may make use of a mediator, or catalyst, within the electrochemical cell. The catalyst may be immobilised on the cathode, such as covalently bound to the cathode. A catalyst may absorbed onto a cathode surface, or may be entrapped within the cathode, such as within the pores of a porous cathode.

The use of immobilised catalysts for the generation of peroxide has previously been described in G.B. Patent No. 2 513 103. The preparation of electrodes with immobilised catalysts is also described in G.B. Patent No. 2 513 103.

The use of a mediator is beneficial as it allows the reaction to proceed at a cathode potential that is independent of the flow rate of the solution through the electrochemical cell. Where oxygen is reduced directly as the cathode, the cathode potential varies with the flow rate of the solution through the electrochemical cell.

The electrochemical generation of peroxide in aqueous solution may comprise supplying a solution containing dissolved oxygen to an electrochemical cell having an anode and a cathode, where the cathode has a catalyst immobilised on the cathode, and applying electrical potential to the cathode to cause catalyzed reduction of dissolved oxygen to peroxide.

The catalyst may be a quinone, such as a quinone comprising a molecule with fused rings, such as two or three fused benzene rings. The quinone may be a compound such as naphthoquinone, anthraquinone, or phenanthrene quinone.

The quinone may bear substituents which do not impede the reaction or induce decomposition of hydrogen peroxide. The quinone may be a compound having hydroxyl substituents, including dihydroxyanthraquinone compounds, such as alizarin (Turkey Red or 1,2-dihydroxyanthraquinone).

Cathodes having quinone compounds immobilised to them, covalently or otherwise, are well known in the art. Example systems are described in further detail below.

The cathode may be carbon, such as glassy carbon. The catalyst may be a porous foam, such as a porous carbon foam.

The cathode may be optically transparent, for example transparent to visible light and/or UV and/or IR light. Accordingly, electrochemical peroxide generators are suitable for use together with optical sensors, and most obviously, UV/vis sensors.

An example transparent cathode for use is an ITO (indium tin oxide) cathode, and such find common use within electrochemical cells where transparent electrodes are required. The ITO electrode is transparent to UV/vis.

Along with ITO, further optically transparent electrodes include doped zinc oxide electrodes, such as aluminum-, gallium- or indium-doped zinc oxide, doped cadmium-oxide electrodes, such as indium-doped cadmium-oxide, graphene films and conducting organic polymers, such as polyaniline. Other transparent electrodes are familiar to those working in the field of electrochemistry.

The anode may be made from a material which does not catalyse the decomposition of peroxide ions. Thus it may be formed of carbon without quinone or other catalyst on its surface. A graphite rod or a carbon mesh may be used.

The anode is a sacrificial metal anode, such as zinc or magnesium. The metal would be stripped electrochemically to form the corresponding ion (for example, Zn²⁺ or Mg²⁺) therefore inhibiting any chemical reaction at the anode.

The arrangement of the cathode, anode and reference electrode, where present, is not particularly limited. However, for the purpose of providing peroxide to the sensor it is sensible to provide the cathode of the cell in close proximity to the sensor, so that peroxide generated at the cathode is similar in close proximity to the sensor.

The anode of the electrochemical cell may be in communication with the aqueous solution flowing over the cathode. In a simple arrangement, the anode may be placed in the flow of the aqueous solution which passes over the cathode, possibly at a position downstream from cathode. Another possibility is that a path of communication through the aqueous solution from cathode to anode is shaped or restricted so that flow from the cathode is largely directed away from contact with the anode. For instance, the anode may be in a branch from the main flow of the aqueous solution so that although there is still a continuous path between the cathode and anode through the aqueous solution, the main flow of aqueous solution containing peroxide items passes the branch without contact with the anode surface. A similar effect could be achieved by a liquid porous material placed between cathode and anode. A further possibility is that aqueous solution is supplied separately to the vicinity of the anode and flows over the anode before merging with the main flow which has passed over the cathode.

The flow of the aqueous solution may contact both the anode and the cathode of the electrochemical cell, whilst electrical potential is provided to the cell. Alternatively a part of the aqueous flow, such as majority of the flow, may contact the cathode, whilst a separate part of the aqueous flow, such as the minority of the flow, may contact the anode, but not the cathode.

The anode and the cathode may be fully immersed in the solution supplied to the electrochemical cell.

The electrolyte for the electrochemical cell may contain water as the only solvent. This is to be expected where the water for the cell is provided from a natural source, although it is conceivable that in the methods described herein other solvents may be present that are miscible with water. The water has oxygen dissolved within it.

The peroxide may be generated in the vicinity of the sensor, such as in the vicinity of the sensor interface. Accordingly, the cathode of the electrochemical cell may be placed in the vicinity of the sensor. The cathode may surround at least part of the sensor, such as at least part of the sensor interface.

The electrochemical cell is also provided with a power supply for supplying electrical potential to the cathode. Where, the reference electrode is present, the potential supplied to the cathode may be controlled relative to the reference electrode.

As noted above, peroxide may be generated in the vicinity of the sensor of the water sensing apparatus. The peroxide may be permitted to diffuse to the sensor may be permitted to contact the surfaces of the sensor, including the surface of the sensor interface. Alternatively the peroxide may be directed to the sensor, for example in an aqueous flow to the sensor. Thus, the peroxide generator may be provided upstream of the sensor in a flowline of the water sensing apparatus.

Thus, there may be provided an apparatus suitable for providing a flow of water through the electrochemical cell to the sensor.

Further, the electrochemical cell may be adapted for use in flow methods. The cathode of the cell may be an electrode through which water may pass through.

Thus, the electrode may be porous, and for example the electrode may be a mesh.

The electrochemical cell is provide with a controller for controlling the voltage applied to the cathode.

The electrochemical cell of the peroxide generator may be used as part of the sensor for analysis of water.

As explained above, the peroxide is generated, as required, at the cathode. It is possible to use the electrochemical cell as an electrochemical sensor for the detection of an analyte within the aqueous solution. The electrochemical reaction of certain species may be detected with a change in the current at the working electrode. Alternatively the electrochemical cell may be used in combination with an optical sensor, which is used to detect the presence of certain electrochemically generated species.

It is appreciated that the presence of a catalyst on the cathode surface may complicate the use of the electrochemical cell as both a peroxide generator and a sensor.

Exemplary systems for carrying out the method of the invention are described in further detail below with reference to the drawings.

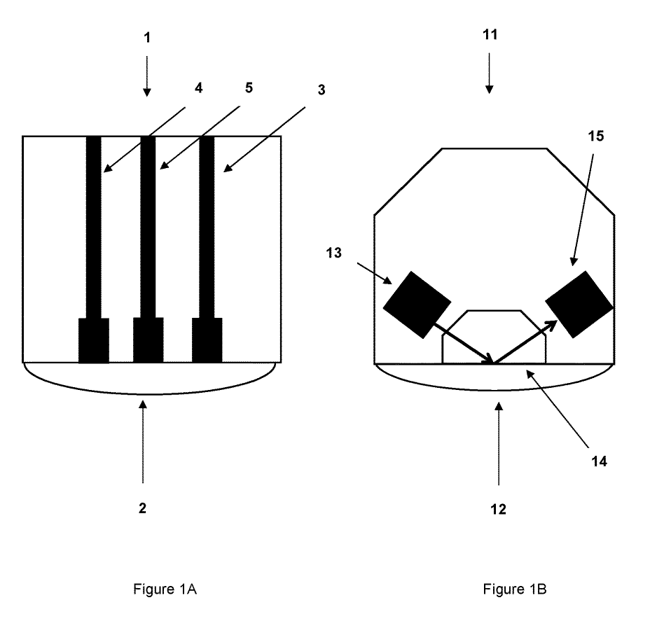

FIGS. 1A and 1B of the drawings show arrangements of a cathode 2, 12 of an electrochemical cell for generating peroxide together with a sensor that is an electrochemical sensor 1 in FIG. 1A and an optical sensor 11 in FIG. 1B. Together an electrochemical cell for generating peroxide and a sensor form part of a water sensing apparatus.

The electrochemical sensor 1 shown has a standard arrangement of a sensing electrode 3, a reference electrode 4 and a counter electrode 5. The cathode 2 is provided in close proximity to the sensing electrode 3.

An electrochemical sensor for analysing the redox properties of analytes in a natural water source, such as the electrochemical sensor 1 of FIG. 1A, may be liable to biofouling, and the electrodes surfaces may become contaminated during sustained used of the electrochemical sensor. Biofouling may negatively affect the performance of the electrodes and may also negatively affect fluid movement through the electrolyte space of the cell.

The optical sensor 11 shown is an IR sensor, having a source of IR radiation 13 which is incident upon an ATR window 14, and an IR detector 15, with appropriate filters for analysing the reflected IR radiation (shown schematically in the figure) from the ATR window 14. The ATR window 14 contacts the aqueous solution to be analysed. A cathode 12 is provided in close proximity to the ATR window 14.

An optical sensor for analysing the optical properties of analytes in a natural water source, such as the optical sensor 11 of FIG. 1B, may also be liable to biofouling. For example, where the optical sensor has windows or lenses for the passage of light, the surfaces of these windows and lenses may become covered with biological material. The amount of light passing across the window or lens may be reduced as a consequence, reducing the performance of the optical sensor.

An electrochemical cell may be provided for the generation of peroxide. The cell has a cathode 2, 12 (working electrode), and the cathode may have immobilised to it a catalyst, such as a quinone compound. The electrochemical cell may be further provided with an anode (counter electrode) and a reference electrode and a power supply for applying a potential to the cathode.

Where the sensor is an electrochemical sensor, the electrochemical cell for the generation of peroxide may share one or more electrodes with the electrochemical sensor. Thus, in the electrochemical system of FIG. 1, the electrochemical cell for the generation of peroxide may include the cathode 2 as well as the reference electrode 4 and the counter electrode 5. Alternatively, the electrochemical cell for the generation of peroxide may be provided with a separate anode and/or reference electrode. Such is necessary on the optical system, where a counter anode is required (not shown).

The cathode 2 may be adapted to allow aqueous fluid to flow through it. Thus, the cathode may take the form of a porous electrode, such as a mesh.

An aqueous fluid is supplied to the electrochemical cell and is permitted to contact the cathode 2, 12. The aqueous fluid may be water from a natural source, and the water is supplied to the cell without chemical purification. The fluid has oxygen dissolved within it.

When an electrical potential is applied to the cathode 2, 12, dissolved oxygen within the fluid is reduced, such as catalytically reduced, to form peroxide.

The electrochemically generated peroxide is permitted to move from the cathode 2, 12 to the sensor, and ideally is permitted to move to those parts of the sensor that contact the fluid during analysis (the sensor interface). Thus, the peroxide may be permitted to contact the electrodes 3, 4, 5 of the electrochemical sensor, and particularly the sensing electrode 3, and the window 14 and lenses (where present) of the optical sensor.

The cathode 2, 12 for generating peroxide is therefore placed in the vicinity of the sensor, and more particularly in the vicinity of the sensor interface. When peroxide is produced it may diffuse from the cathode 2 to the sensor 1, 11. Alternatively the cathode 3 and the sensor 1, 11 may be provided in a flow path, with the cathode 3 located upstream of the sensor 1, 11. Thus, peroxide produced at the cathode 3 is directed downstream towards the sensor 1, 11 in a flow of an aqueous solution.

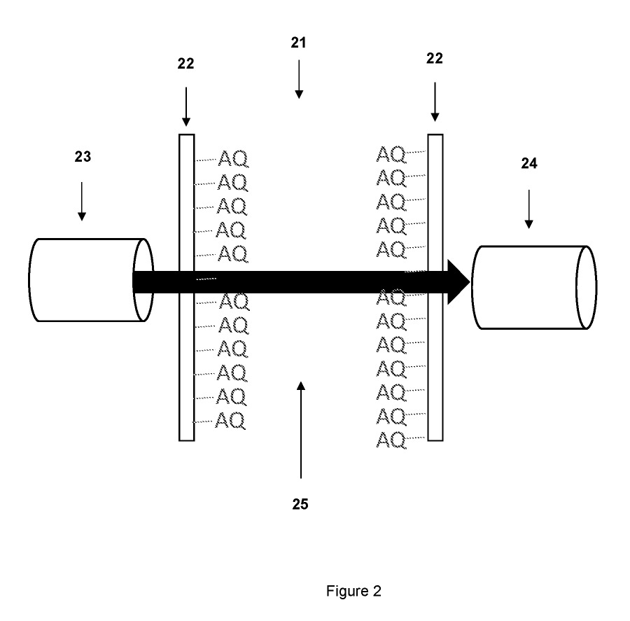

FIG. 2 of the drawings shows part of a water sensing apparatus having an electrochemical peroxide generator and an optical sensor 21. The water sensing apparatus has an arrangement of two transparent cathodes 22 of an electrochemical cell for generating peroxide together with an optical sensor 21 having a light emitter 23 (light source) and a light detector 24. Each cathode 22 has immobilised to it an anthraquinone (AQ) catalyst. The use of transparent cathodes allows the cathodes 22 to be placed directly within the detection path of the optical sensor 21. Thus, light may be passed from the light emitter 23 through a cathode 22 and the light may illuminate analytes that are located in the electrolytic space 25 (here, the electrolytic space referring to the space between cathodes 22, rather than the space between a cathode and an anode). A cathode 22 is placed in close proximity to the light emitter 23 to ensure that peroxide is generated close to the light emitter 23, thereby preventing or inhibiting the formation of biological deposits on the light emitter 23, such as on a window or a lens of the light emitter.

Light that is transmitted through or reflected in the electrolyte space 25 may be detected by an optical detector 24 that is placed at an appropriate location around the electrochemical cell. A cathode 22, such as in addition to the cathode 22 described above, may be placed in close proximity to the optical detector 24 to ensure that peroxide is generated close to the optical detector 24, thereby preventing or inhibiting the formation of biological deposits on the optical detector 24, such as on a window or a lens of the optical detector.

In an example embodiment, a UV/vis optical sensor may be used, with a light emitter emitting in the UV/vis range and an appropriate detectors for measuring UV/vis transmittance. Here, ITO-based electrodes are suitable for use as such are substantially transparent to light in the UV/vis range. Other transparent electrodes may be used in place of ITO, such as those electrodes discussed in the description above,

The electrochemical cell may be operated intermittently to generate peroxide local to the optical sensor. In between the operation of the electrochemical cell, the optical sensor may be used to detect analytes within the electrolyte space. A water sample may be flowed through the electrolyte space.

In a further variation, the electrochemical cell for generating peroxide may also be used as an electrochemical sensor for detecting the presence of redox active analytes within the water sample. Thus, the cell may be operated to reduce or oxidise analytes within the electrolyte space. These reduced or oxidised analytes may be detected from the electrochemistry measurements and/or the optical sensors may be used to identify and characterise reduced or oxidised analytes.

The inventors have established that an electrochemical cell may be operated as a peroxide generator and also as an electrochemical sensor, for example for measuring the pH of a solution. For example chronoamperometry may be used to generate peroxide at the cathode of the cell. Square wave voltammetry may be used for pH measurements. It is foreseeable that in a single voltammetric sweep the pH of an aqueous solution may be measured, whilst also generating peroxide for biocidal treatment of the sensor surfaces.

The cathodes of the electrochemical peroxide generator typically have a catalyst attached to them, covalently or otherwise, and quinones are particularly useful catalysts for the electrochemical generation of peroxide. An electrochemical sensor for the measurement of pH has been described by Dai et al. where the working electrode is provided with quinone dihydroxyanthraquinone.

Thus, Dai et al. describe the preparation of an alizarin electrode where a carbon ink is ball milled with alizarin, and the mixture screen printed and dried. Square wave voltammetry measurements using the alizarin electrode against pH buffer solutions showed that there was a linear relationship between the pH of the test solution and the recorded oxidative peak potential.

Electrodes of the type described by Dai et al., the contents of which are hereby incorporated by reference, may be used as an electrochemical sensor in the methods and apparatus of the present invention.

The electrodes of the electrochemical peroxide generator may be adapted as required to allow the cell to operate as an electrochemical sensor for the detection of a particular analyte. Further mediator (catalysts) may be provided in the electrochemical cell, such as immobilised to a working electrode, to mediate a chemical reaction involving an analyte of interest. A mediator having a high redox potential may be used for this purpose, and this mediator may be used together with the quinone catalysts described herein in a dual redox system.

A dual redox system making use of quinone compounds are known to be useful for detecting the presence of hydrogen sulfide and oxygen, whilst also permitting the pH of an aqueous solution to be determined. A system of this type is described by Lafitte et al. which is incorporated by reference herein.

Briefly, Lafitte et al. describe the immobilisation of a ferrocene-modified anthracene compound on to the surface of a carbon electrode. Such is useful for the detection of oxygen and the measurement of pH.

Square wave voltammetry measurements using the modified electrode against pH buffer solutions showed that there was a linear dependence between a low potential redox wave associated with anthracene redox electroactivity and pH. The difference in redox activity between the anthracene wave and the ferrocene wave also shows a liner dependence upon pH.

The cyclic voltammetric response of the modified electrode was shown to differ when oxygen was present and absent. Particularly, the presence of oxygen led to an increase in the reductive current along with a decrease in the oxidative current. The authors recognised that such change could be used for at least the qualitative determination of oxygen concentration. Further, the determination of oxygen content in this way did not affect the ability of the system to determine pH. Thus, the peak potential was found to be independent of oxygen concentration.

Accordingly, electrodes of the type described by Lafitte et al. may be used as an electrochemical sensor in the methods and apparatus of the present invention.

It will be appreciated that the example embodiments described in detail above can be modified and varied within the scope of the concepts which they exemplify. Features referred to above or shown in individual embodiments above may be used together in any combination as well as those which have been shown and described specifically. Accordingly, all such modifications are intended to be included within the scope of this disclosure as defined in the following claims.

### REFERENCES

All documents mentioned in this specification are incorporated herein by reference in their entirety for all purposes.

Dai et el., Electroanalysis 27, 917 (2015).

Delauney et al., Ocean Sci. 6, 503 (2010).

G.B. Patent No. 2 513 103

Lafitte et al., Electrochemistry Comm. 10, 1831 (2008).

1. A method for preventing or limiting biofouling of a water sensing apparatus, the method comprising:
generating peroxide in the vicinity of a sensor of the water sensing apparatus.

2. The method of claim 1, wherein the peroxide is generated from an aqueous solution having oxygen dissolved within.

3. The method of claim 1, wherein the sensor is submerged in water.

4. The method of claim 2, wherein the aqueous solution is from a natural water source, such as without chemical purification.

5. The method of claim 1, wherein the peroxide is generated electrochemically at the cathode of an electrochemical cell.

6. The method of claim 5, wherein a catalyst immobilised on the cathode.

7. The method of claim 6, wherein the catalyst is a quinone.

8. The method of claim 5, wherein the cathode comprises carbon and/or glassy carbon.

9. The method of claim 5, wherein the cathode is transparent to visible light.

10. The method of claim 9, wherein the cathode comprises ITO.

11. The method of claim 1, wherein the sensor comprises an electrochemical sensor or an optical sensor.

12. The method of claim 11, wherein sensor is an electrochemical sensor and the peroxide is generated electrochemically at the cathode of the electrochemical sensor.

13. The method according to claim 1, further including the step of operating the sensor after the step of generating peroxide.

14. A water sensing apparatus comprising:
a sensor; and
a peroxide generator.

15. The water sensing apparatus of claim 13, wherein the sensor and the peroxide generator are configured in use to be submerged in the water.

16. The water sensing apparatus of claim 14, wherein the sensor comprises an electrochemical sensor or an optical sensor.

17. The water sensing apparatus according to claim 14, wherein the peroxide generator comprises an electrochemical peroxide generator.

18. The water sensing apparatus of claim 17, wherein the electrochemical peroxide generator is also an electrochemical sensor.

19. The water sensing apparatus according to claim 14, further comprising:
a pump for flowing the water over the sensor.

20. The water sensing apparatus according to claim 14, wherein the sensor comprises an electrochemical pH sensor.

21. The water sensing apparatus according to claim 17, wherein one of the electrodes of the electrochemical peroxide generator comprises a mesh disposed above a sensing surface of the sensor.
